(19) United States
(12) Patent Application Publication
(10) Pub. No.: US 2006/0082662 A1
(43) Pub. Date: Apr. 20, 2006

(54) System and process for digitizing and tracking audio, video and text information

(76) Inventor: Brian Isaacson, Glen Cove, NY (US)

Correspondence Address: WILLIAM COLLARD;COLLARD & ROE, P.C., 1077 NORTHERN BOULEVARD, ROSLYN, NY, 11576, US

(21) Appl. No.: 10/966,208

(22) Filed: Oct. 15, 2004

(51) Int. Cl. H04N 5/76

(52) U.S. Cl. 348/231.99

(57) ABSTRACT

A process for storing and archiving a live recording. This process can comprise the steps of receiving video information, receiving audio information, and then transforming the audio information into text information. All of this information can then be matched to a plurality of discrete elements of the video information, the audio information, and the text information with a time code so that each of these plurality of discrete elements of video information, audio information and text information are synchronized with a particular time code. Accordingly this process can also include the transformation of the video signal and the audio signal from an analog signal into a set of digital information. Each video frame would then be identified, wherein each frame is then matched with a discrete time code for identification. The corresponding audio code along with the text code is synchronized with the video code so that each one of the discrete units of digital information are matched with a time code.

### CROSS REFERENCE TO RELATED APPLICATIONS

This application claims priority under 35 U.S.C. 119e from U.S. Provisional application Ser. No. 60/510,863 filed on Oct. 14, 2003, the disclosure of which is hereby incorporated herein by reference.

### BACKGROUND OF THE INVENTION

1. Field of the Invention

The present invention relates to a system and process for digitizing and tracking audio, video and text information. This information can be used to monitor a legal proceeding such as a deposition or examination before trial.

2. The References

Other types of systems and processes for digitizing and tracking audio and video information are known. For example, U.S. Pat. Nos. 5,172,281 5,172,284 5,272,571 4,924,387 5,832,171 5,878,186 5,884,256 6,023,675 5,790,141 5,949,952 5,745,875, 5,701,153, 5,729,741, 5,564,005, 5,550,966, 5,535,063, and 5,280,430 relate to systems and processes for recording audio and video information, the disclosures of which are hereby incorporated herein by reference.

### SUMMARY OF THE INVENTION

The invention relates to a process for storing and archiving a live recording. This process can comprise the steps of receiving video information, receiving audio information, and then transforming the audio information into text information. All of this information can then be matched to a time code whereby a plurality of discrete elements of the video information, the audio information, and the text information can be matched with a time code so that each of these plurality of discrete elements of video information, audio information and text information are synchronized with a particular time code. Accordingly this process can also include the transformation of the video signal and the audio signal from an analog signal into a set of digital information. Each video frame would then be identified, wherein each frame is then matched with a discrete time code for identification. The corresponding audio code along with the text code is synchronized with the video code so that each one of the discrete units of digital information are matched with a time code.

The invention can also relate to a system for storing and archiving a live recording comprising a camera for capturing video information, a plurality of microphones, and a priority mixer coupled to the microphones for mixing a selected sound from these microphones. This system can also include a multi-signal capture device for synchronizing a receipt of a video and an audio signal. This multi-signal capture device can be in any known form but can be for example in the form of a Winnov® video capture board which is coupled to a personal computer. There can also be a speech to text converter for converting audio information received from the priority mixer into a set of text. The speech to text converter can be in the form of a system or program stored on a personal computer. There can also be an encoder for digitizing the video signal, and the audio signal and forming the video signal and the audio signal into a set of discrete units. This type of encoder can be in the form of a plurality of encoding instructions stored on a standard personal computer. There can be a time generator for creating a time stamp for each of the discrete digital video and audio units.

In addition, this system and process can be particularized for a deposition or pretrial examination. For example, prior to starting a recording session, a user can input information relating to that particular recording session into a database to categorize that recording session. This information can be in the form of a location of the deposition, or examination, a case number, a case name, a name of a plaintiff's attorney, a name of a defendant's attorney and the name of an Examinee.

Thus, once this information has been recorded, a user can then subsequently search for this information through a database to then subsequently retrieve a particular recording session from this database.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1A shows a schematic block diagram of a system for digitizing and tracking audio, video, and text information;

FIG. 1B shows a block diagram of a networked system as shown in FIG. 1A

FIG. 2 shows a flow chart of a process for encoding video, audio and text with an associated time/date stamp;

FIG. 3 shows a flow chart of a process for recording a deposition;

FIG. 4 is a screen relating to a log-in screen;

FIG. 5 is a screen relating to a set of fields or prompts for inputting categorization information;

FIG. 6 is a screen relating to a listing of text and video information;

FIG. 7 is a screen relating to a listing of text information;

FIG. 8 is a screen relating to a listing of the searchable categorization information relating to a recorded session;

FIG. 9 is a screen relating to a particular searched batch set of information which lists a plurality of sessions; and

FIG. 10 is a screen relating to the playing of a selected session.

### DETAILED DESCRIPTION OF PREFERRED EMBODIMENTS

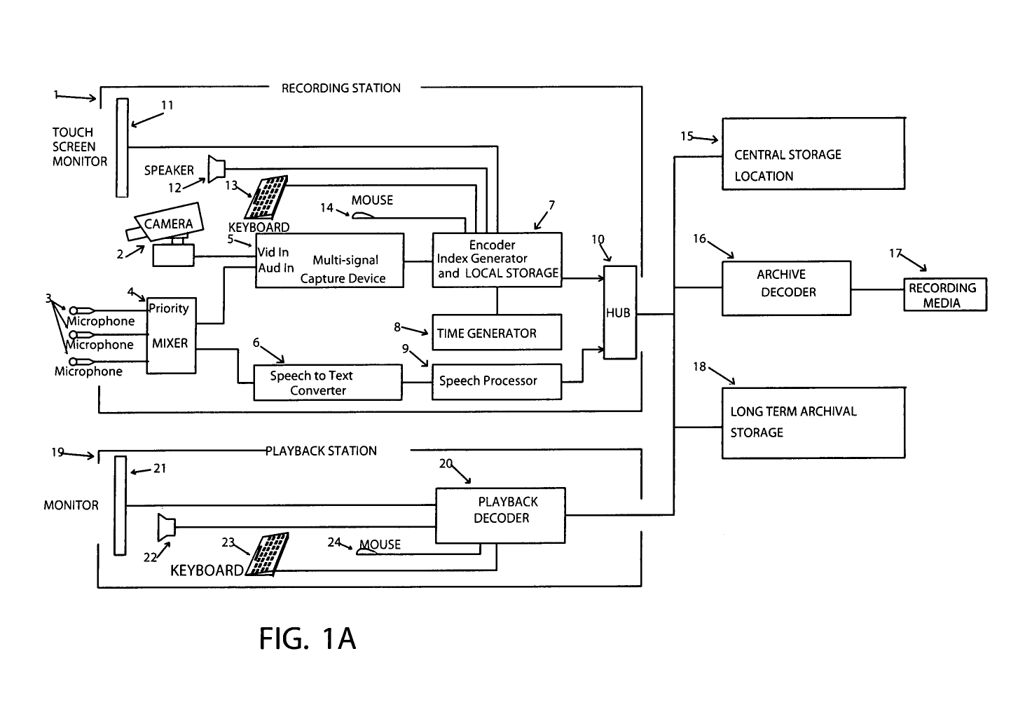

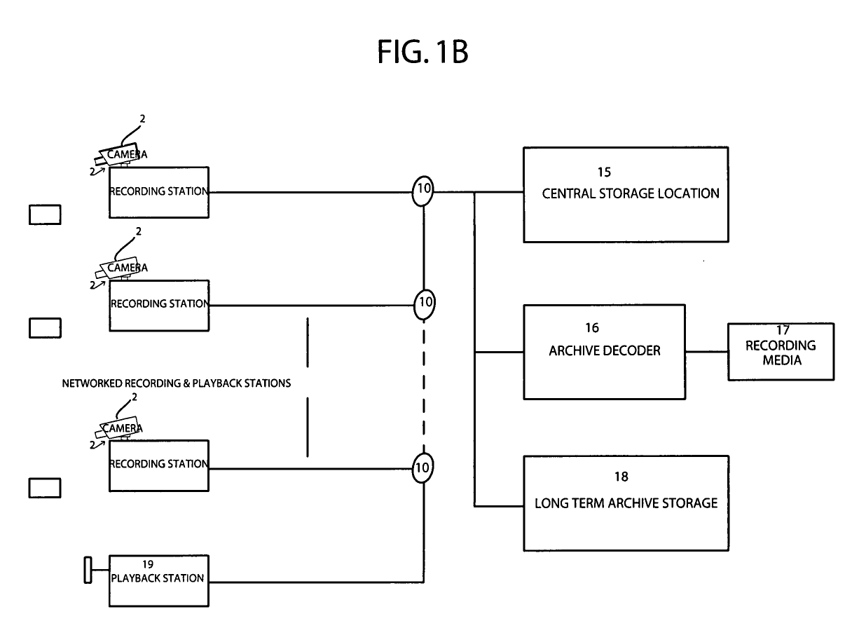

Turning now in detail to the drawings, FIG. 1A shows a schematic block diagram of a system for digitizing and tracking video, audio and text information. This system 1 includes a camera 2, and at least one or a plurality of microphones 3, which are in communication with a priority mixer 4. Priority mixer can be in the form of a Shure® priority mixer which is known in the art. Both camera 2, and priority mixer 4 are in communication with a multi-signal capture device 5 which can be in the form of a Winnov® video capture board which captures both the audio signal and the video signal simultaneously. This information is then forwarded onto an encoder 7, wherein this information is then transformed from an analog signal into a digital signal so that both of the audio signal and the video signal are in digitized form, which includes discrete and separate digital units that are synchronized to each other. Both the capture device and the encoder can be incorporated into a standard personal computer, wherein this personal computer includes a plurality of instructions to control the receipt, storing and encoding of audio, video and text information.

There is also a time generator 8 which is in communication with encoder 7. Time generator 8 essentially matches a time code with a particular digitized frame received from camera 2 or a set of audio recording or text. Time generator 8 can be in the form of a series of instructions or a program stored on a personal computer such as the same personal computer for housing encoder 7 and multi signal capture device 5.

In this case, many cameras can record approximately 30 frames per second. Therefore, time generator 8 can, for example, create 30 distinct separate time codes per second and then match each of these time codes with a particular digitized video frame or audio segment.

For example, each analog audio signal is simultaneously sent from priority mixer 4 to both speech to text converter 6 and also to multi-signal capture device 5. This information is then immediately forwarded on to encoder 7 and also on to speech processor 9. The analog audio signals entering encoder 7 and speech processor 9 are immediately and simultaneously converted into discrete digital units in a synchronized manner. Time generator 8 is in communication with encoder 7 and also with speech processor 9 such that each of these digital units in both encoder 7 and speech processor 9 is stamped or encoded with a specific time code. Accordingly, any text associated with the digitized audio signal is stamped with a time code as well. Therefore, each of these synchronized parts of video, audio and text are encoded with particular time generating identifiers so that all of these parts can be particularly synchronized. In a simplified embodiment, speech to text converter 6 and speech processor 9 are in the form of a series of instructions or program that is stored on a personal computer, wherein this personal computer can be the same personal computer used for encoder 7 or a different personal computer.

This encoded information can then be relayed to a hub 10 which can then allow a central storage location 15, an archive decoder 16, and a long term archival storage device 18 to receive and store this information. Audio, visual and text information can then also be forwarded to a touch screen monitor 11, and a speaker 12.

To provide for control of this device, there is a keyboard 13, and a mouse 14 which allows a user to control this information. Furthermore, touch screen monitor 11 can be disposed in an offsite location and can include a plurality of keys for allowing a user to control a particular camera. For example, touch screen monitor 11 can include a toggle key to toggle between a first camera 2 and another camera on site (not shown). In addition, touch screen monitor can also include a pan key to cause camera 2 to pan or scan a room. Furthermore touchscreen 11 can also include activating keys to adjust a horizontal or vertical rotation or adjustment of camera 2 along with keys for play, record, stop, fast forward and rewind. This functionality in touch screen monitor 11 allows a user to operate this system from a remote location.

In addition, this information can also be forwarded from hub 10 onto a playback station 19 which can include a playback decoder 20, a monitor 21, a speaker 22, a keyboard 23, and a mouse 24. Playback decoder 20 can be in the form of a personal computer having instructions for playing back this information. Thus, on this system, the images, text and audio can be reviewed as on synchronized output, and searched based upon a particular time period or a set portion of text.

A networked array of this system can be shown in FIG. 1B which discloses a plurality of offsite recording stations along with a networked playback station 19 which can be used to control one or more of these recording stations using a touch screen 11 having the controls listed above.

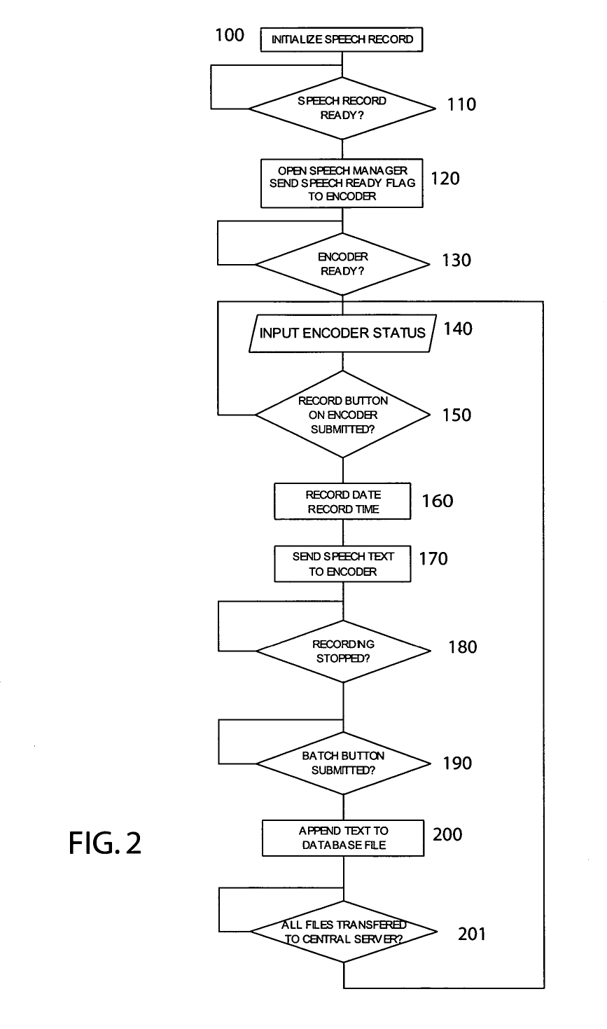

Essentially, the process for digitizing and time coding the video, audio and text proceeds through a series of steps as shown in FIG. 2. This process includes step 100 which involves an initialization of a speech record, which results in the creation of a new record for storage. Next, in step 110, the system in the form of encoder 7 and processor 9 check to determine whether the speech record is ready. Next, in step 120, a speech manager in the form of a program which may be stored on a computer or stored in memory and separately associated with either encoder 7 and speech processor 9, opens and sends a speech ready flag to encoder 7. Step 130 involves confirming whether encoder 7 and processor 9 are ready to receive analog audio and video information. Step 140 involves inputting the encoder status which can include whether the encoder and the speech processor 9 are ready to receive new information.

Step 150 involves submitting a recording request, which can be submitted either through pressing a record button on camera 2 or by pressing a record button on touch screen 11. Once the record button has been pressed, the encoder receives this analog audio/video information and synchronously digitizes this information into a series of discrete digital units based upon a set of video frames. Therefore, in this digitization process, the analog audio units and the analog video units are divided up based upon each video frame and then set as corresponding digital units.

Therefore, if there are 30 video frames recorded per second, each of these frames is converted into a digital unit, and then the corresponding analog audio signal is also segmented and recorded as a corresponding digital unit in both encoder 7 and also in speech processor 9. Speech processor 9 also stamps or encodes the corresponding digital unit of text which is the corresponding text associated with this process. The end result of this process is that all of the digital units of video, audio and text are synchronized and matched based upon a particular corresponding time/date stamp or identifier as disclosed in steps 160 and 170 wherein these synchronized digital units are then all simultaneously searchable based upon this time/date stamp.

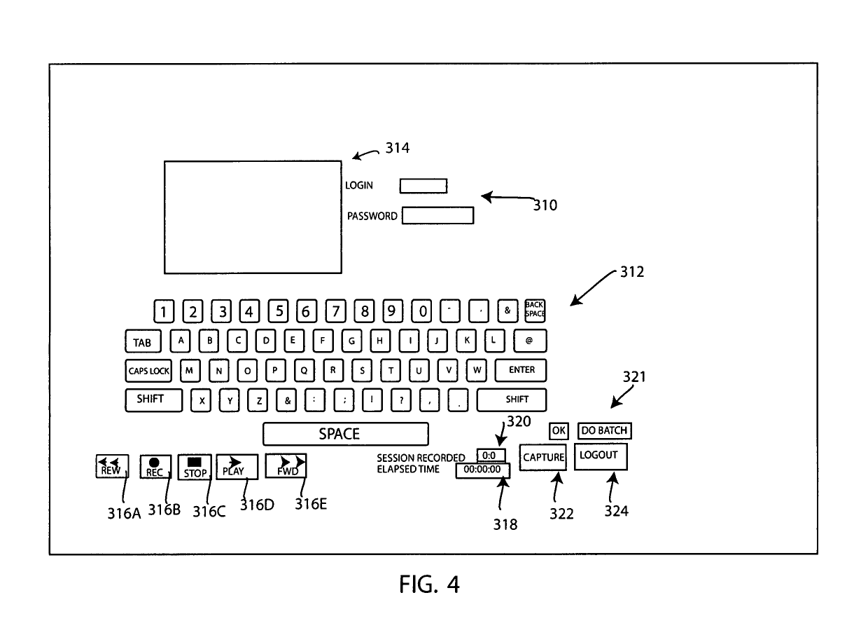

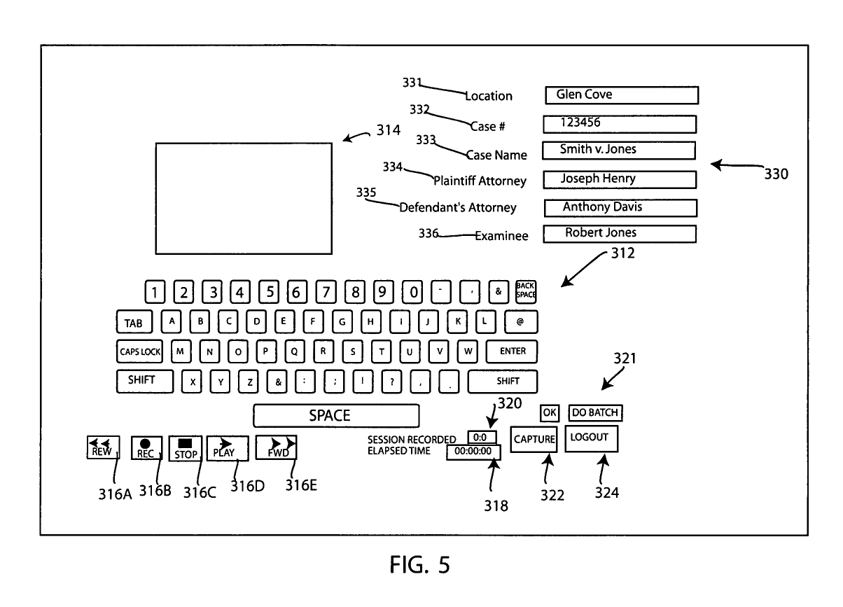

In step 180, the system can determine whether a recording has stopped. This can occur if a user hits a stop button on either camera 2 or on touch screen 11 (see FIG. 5). Next, the system in step 190 determines whether a batch button 321 (See FIG. 4) has been pressed or submitted. Each deposition or meeting can be segmented or divided into different groups by different sessions and different batches. At least one session or a plurality of sessions can form a single batch session. The sessions are listed on a user screen as shown in FIG. 4 and these sessions represent a start-stop cycle for camera 2, encoder 7 and speech processor 9. Once all of the sessions have been compiled, a batch of these sessions can be submitted by pressing batch button 321.

Step 200 involves appending this information to a database file wherein this database file can, in step 201, be transferred and stored in either a central storage location 15, an archive decoder 16, or in a long term archival storage unit 18 as shown in FIG. 1A.

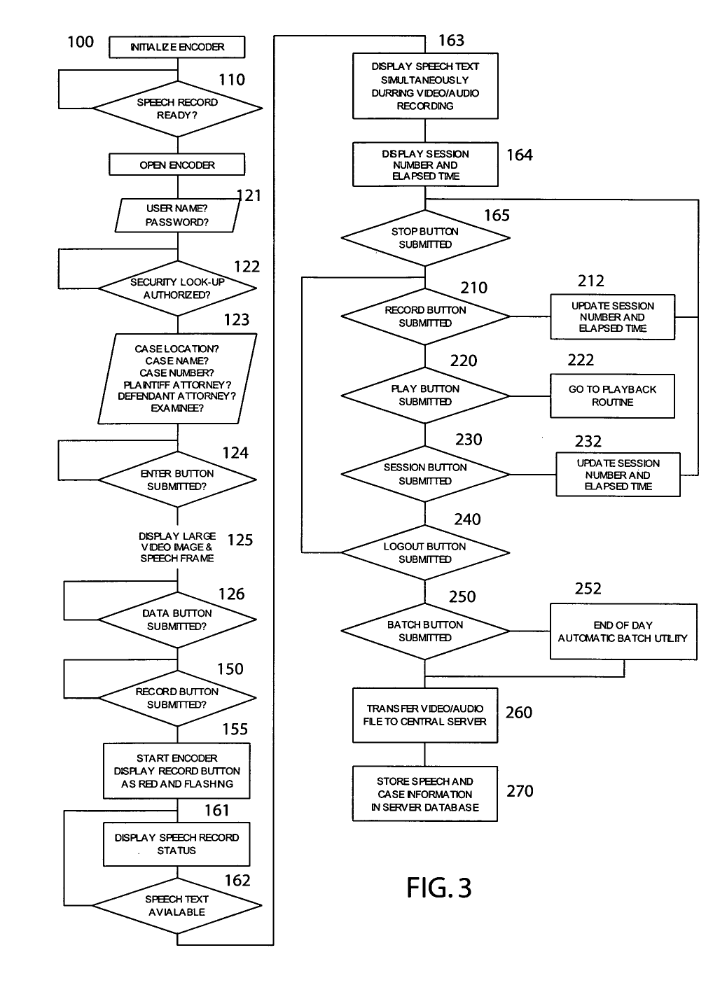

FIG. 3 shows the flow chart or process for this type of recording session as it pertains to recording a legal proceeding. In this case, the system can proceed through steps 100, 110, and 120 as described above. However, in this case, a user can log into the system in step 121, on terminal 11 as shown in FIGS. 1 and 4 and enter his or her username and password into a login prompt 310. FIG. 4 shows as user screen which includes login prompt 310, a touch keypad 312, a plurality of recording and playback buttons 316 including a rewind button 316A, a record button 316B, a stop button 316C, a play button 316D, and a fast forward button 316E.

This screen can also show the number of sessions recorded 320, a readout of the elapsed time 318, a batch button 321, a capture button 322 and a logout button 324. In this case, capture button 322 can be used to capture a particular frame, or segment, or time period wherein this frame, segment or time period can be saved as a separate file from the remaining ongoing recording.

In step 122, the system performs a security look up to authorize whether a particular user is authorized to use this particular system. Next, once the user has been authorized, in step 123, a user is presented with a prompt to enter in his or her case information. The prompt to enter this information is shown in FIG. 5 as a set of fields 330. These fields include a location field 331, a case # field 332, a case name field 333, a plaintiff's attorney field 334, a defendant's attorney field 335, and a examinee field 336. Once all of these fields have received their proper information and entered, a user can press on an enter key in keyboard 312 in step 124.

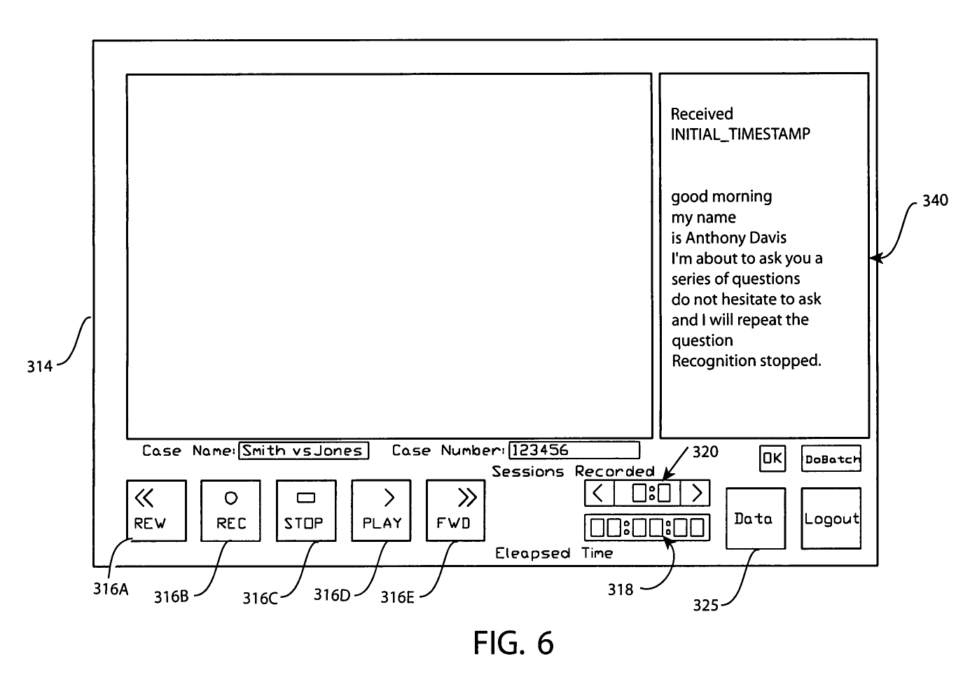

Step 125 discloses that upon entering the information into the database, a large video image 314 and speech frame 340 can be disclosed to the user so that once the data button 325 (FIG. 6) has been submitted in step 125, and the record button 316B has been submitted in step 150, the system can start recording video, audio and text information.

For example, in step 155, upon initializing a recording, the encoder in either encoder 7 or speech processor 9 starts, wherein the record button can be displayed as red or flashing.

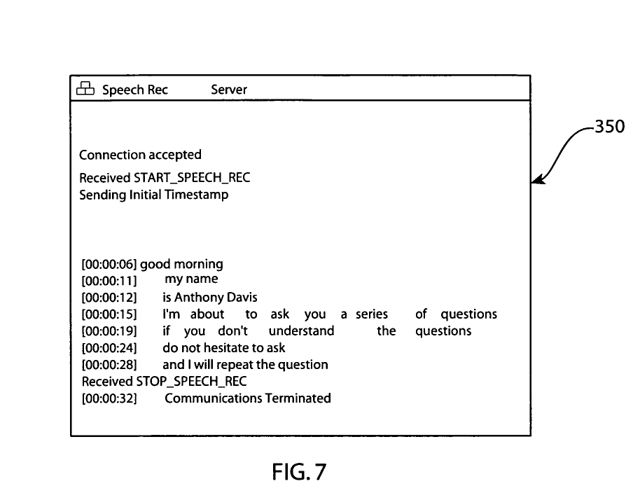

Next, in step 161, as shown in field 340 in FIG. 6, a speech record status can be shown, wherein in step 162, this separate speech text can be shown in a separate screen as shown in FIG. 7. This process allows for the display of speech text simultaneously during video and audio recording as shown in FIG. 6 via video image 314 and field 340. In addition, in step 164, the session number and elapsed time can be shown in a session recorded image 320 and also in an elapsed time image 318.

To stop a particular recording, a stop button command can be submitted in step 165 which thereby ends a session with the pressing of a stop button 316C. At this point the user can at his or her option start another session by pressing a record button 316B again in step 210. If this event occurs, step 212 updates the system to create a new session number and elapsed time. Alternatively, a play button 316D can be pressed in step 220, which allows the user to review the most recently recorded work through a playback routine in step 222 wherein the recording is looped back.

Alternatively, a user can select a session button in step 230, wherein the user can select to start a new session. If this session is selected, the session number is updated along with the elapsed time. However at this point, the recording does not start until a user selects the record button.

Alternatively the user can select a logout button 240, wherein upon selection of the logout button, the user can next select a batch button 321 in step 250 to signal an end to a batch which can for example occur at the end of a day. Thus, if a user ends a recording, the automatic batch utility is initiated in step 251 to end that particular day's batch. This information is then forwarded onto a central server in step 260, wherein it is stored in a database and categorized in step 270.

The information that is associated with fields 330 can then be used to allow a user to search for any previous recording based upon any of those fields. In addition a user can also search based upon a particular session number as shown in Field 360 or based upon the time and day that the user recorded the session.

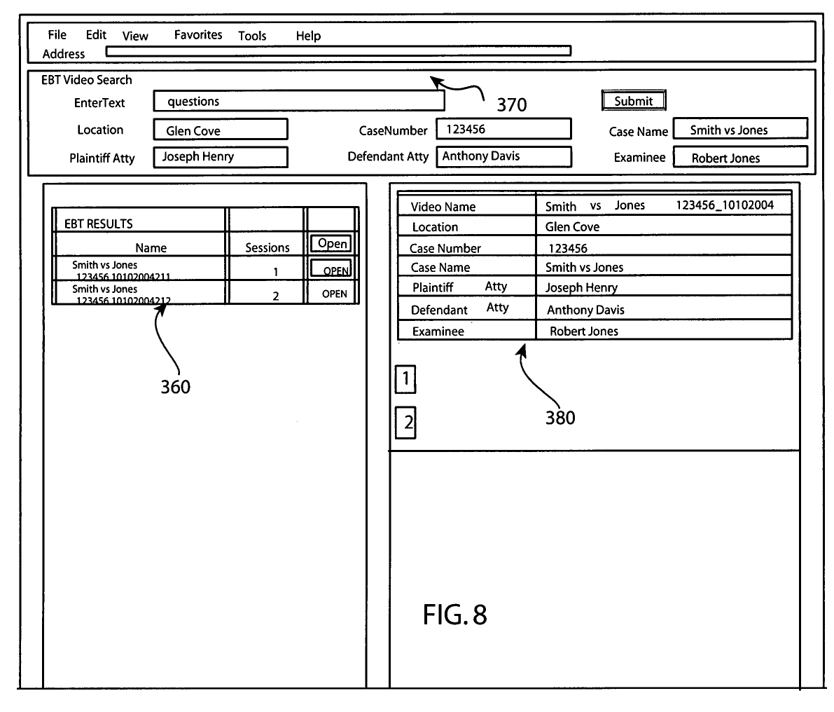

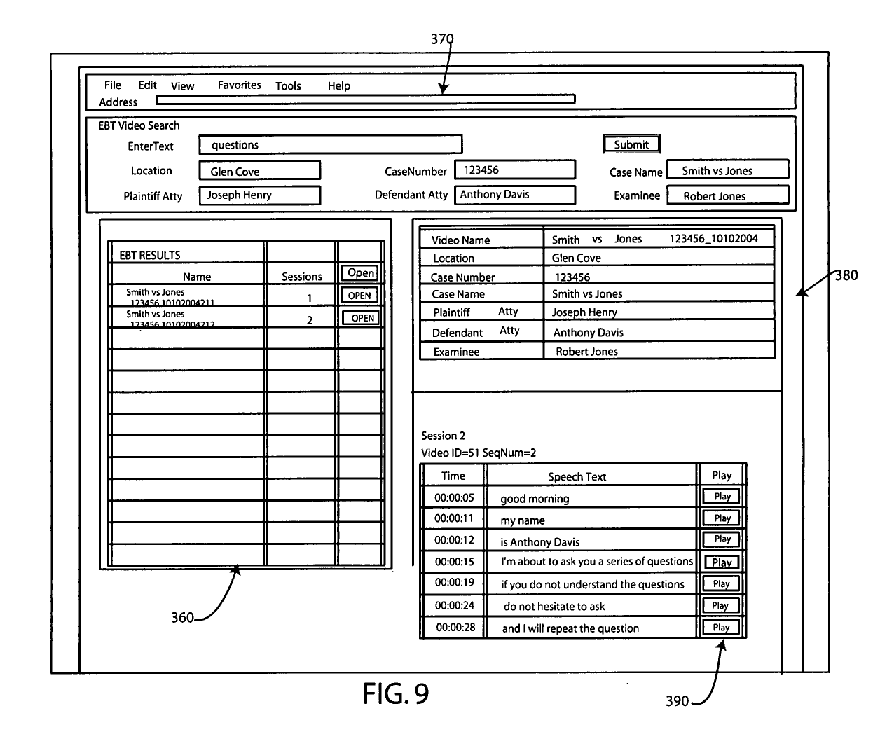

For example, FIGS. 8-10 display the associated screens for playing back or reviewing a particular session on for example, a playback station 20 as shown in FIG. 1A. FIG. 8 shows an initial search screen which discloses a set of indicator fields 370 which are substantially similar to fields 330 in FIG. 5. There is also a listing of the EBT or deposition results in field 360 wherein if a user chooses, he or she can select to open a particular session. The information relating to this session can then be displayed in fields 380. FIG. 9 shows a screen indicating that a particular session has been selected. In this case, session 2 has been selected, wherein upon this selection, information relating to this session is shown in fields 380 and fields 390. In particular, fields 390 include a listing of the speech text along with the time stamp associated with that parcel of text. A user can then select a play button to proceed with the playing of that text. In one embodiment, only that portion of the audio file for that text will be played. However, in another embodiment, the audio file plays forward for that text onward through the later sequential text files as well.

Upon pressing of the play key associated with any of that particular text, a display screen 314 can appear to show any of the particular video and to broadcast any of the associated audio associated with that file.

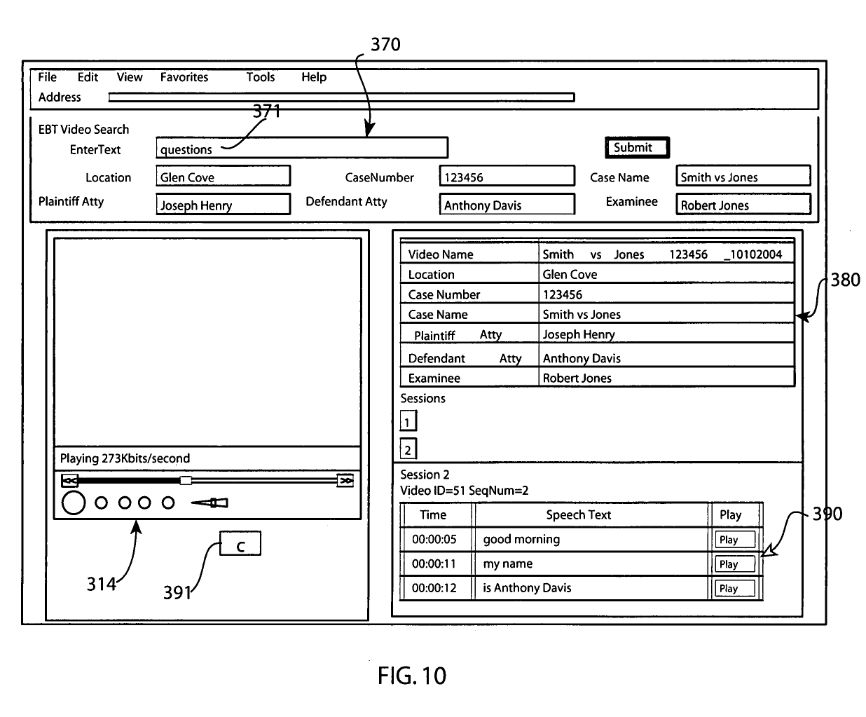

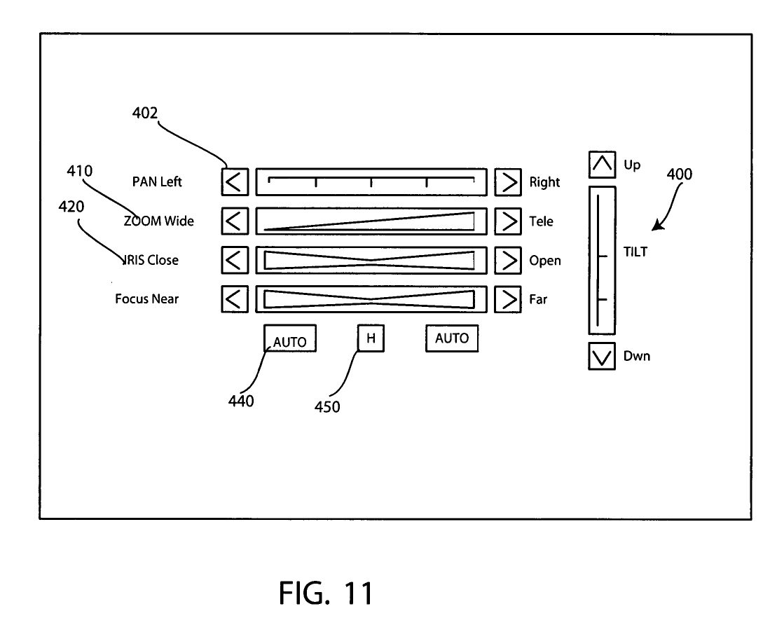

Ultimately, this system and process results in a transformation of video and audio files into a group of synchronized digital files that include video, audio and text, wherein these video audio and text files are synchronized with a corresponding time and date stamp. These files are associated with a session recording, wherein each session recording is then associated with an entire batch recording. Each batch recording can then be categorized and sorted in a database, based upon examination or session information including the following criteria: location; plaintiff's attorney; defendant attorney; case number; case name; and examinee. In addition, once that particular batch of information has been recalled and is presented, the information associated with that batch including any text or time period can be searched as well. A user can search the text by inserting a keyword into a text prompt as shown in field 371 in FIG. 10 to search the text on record. The text search may be conducted using any known boolean search which may be used in the art.

A user can also search for a particular time frame based upon a prompt presented on this screen as well. Furthermore, during this playback time, a user can also select a bookmark which can be in the form of a particular time period that is captured. Each bookmark can be displayed as shown in fields 390 in FIG. 10 with the particular bookmarked time period, and the associated text disposed adjacent to this bookmarked time period. The user can select this bookmark by hitting a capture button 391 disposed adjacent to display screen 314.

FIG. 11 shows a view of an embodiment of a touch screen 11 which can be used to control any one of a camera 2 disclosed in FIG. 1B or 1A. FIG. 11 shows that touch screen 11 can include a vertical adjusting control or tilt 400, a horizontal adjusting control or pan 402, a zoom control 410, and a plurality of buttons an iris close or open control 420, a focus near or far control 430, an auto focus control 440 and a home button 450.

Accordingly, while a few embodiments of the present invention have been shown and described, it is to be understood that many changes and modifications may be made thereunto without departing from the spirit and scope of the invention as defined in the appended claims.

What is claimed is:

1. A process for storing and archiving a live recording comprising:
a) receiving video information;
b) receiving audio information;
c) transforming said audio information into text information; and
d) matching a plurality of discrete elements of said video information, said audio information, and said text information with a time code so that each of said plurality of discrete elements of video information, audio information and text information are synchronized with a particular time code.

2. The process as in claim 1, further comprising the step of transforming said received video information from an analog signal into discrete elements of digital information.

3. The process as in claim 1, further comprising the step of transforming said received audio information from an analog signal into discrete elements of digital information.

4. The process as in claim 1, wherein said test information is stored as discrete elements of digital information.

5. The process as in claim 2, further comprising the step of transforming said received audio information from an analog signal into discrete elements of digital information wherein said text information is stored as discrete elements of digital information.

6. A system for storing and archiving a live recording comprising:
a) a camera for capturing video information;
b) at plurality of microphones;
c) a priority mixer coupled to said plurality of microphones for mixing a selected sound from said plurality of microphones;
d) a multi-signal capture device for synchronizing a receipt of a video and an audio signal;
e) a speech to text converter for converting audio information received from said priority mixer into a set of text;
f) an encoder for digitizing said video signal, and said audio signal and forming said video signal and said audio signal into a set of discrete units; and
g) a time generator for creating a time stamp for each of said discrete digital video and audio units.

7. The system as in claim 6, further comprising at least one speech processor for simultaneously and synchronously digitizing said audio signal separate from said video signal and for applying a time stamp to said discrete digital audio units and said text to synchronize said digital audio units with said text.

8. The system as in claim 7, further comprising a playback decoder which can be used for playing back said synchronized digital video units, digital audio units and text; a central storage location in communication with said encoder for storing said synchronized digital video units, digital audio units and text.

9. The system as in claim 8, further comprising a long term archival storage unit in communication with said encoder for storing said stored synchronized digital video units, digital audio units and text, and an archive decoder for replaying said stored synchronized digital video units, digital audio units and text from said central storage location or from said long term archival storage.

10. A system for storing and using a live recording comprising:
a) a camera for capturing video information;
b) at least one microphone;
c) a touch screen in communication with said camera for controlling a set of functions of said camera;
d) a multi-signal capture device for synchronizing a receipt of a video and an audio signal;
e) a speech to text converter for converting audio information received from said priority mixer into a set of text;
f) an encoder for digitizing said video signal, and said audio signal and forming said video signal and said audio signal into a set of discrete units; and
g) a time generator for creating a time stamp for each of said discrete digital video and audio units.

11. A process for storing and using a live recording comprising:
a) initializing a recording session by opening an encoder;
b) inputting information into a database to categorize said recording session;
c) receiving video information;
d) receiving audio information;
e) transforming said audio information into text information; and
f) matching a plurality of discrete elements of said video information, said audio information, and said text information with a time code so that each of said plurality of discrete elements of video information, audio information and text information are synchronized with a particular time code.

12. The process as in claim 11, wherein said step of inputting information in said database includes inputting information taken from the group consisting of: location of recording; case number; case name; plaintiff attorney; defendant attorney; and examinee.

13. The process as in claim 12, further comprising the steps of searching for a particular recording session based upon the inputted information associated with that particular recording session, and retrieving a particular recording session based upon said search.

14. The process as in claim 13, further comprising the step of inserting an electronic bookmark into a recording, allowing a user to subsequently retrieve a time and date location in said recording based upon said bookmark.
